(19) United States
(12) Patent Application Publication
(10) Pub. No.: US 2024/0281529 A1
(43) Pub. Date: Aug. 22, 2024

(54) METHOD TO OPTIMIZE CREATION OF RESTORE POINTS FOR EFFECTIVE USE OF DISK SPACE

(71) Applicant: Dell Products L.P., Round Rock, TX (US)

(72) Inventors: Parminder Singh Sethi, Ludhiana (IN); Lakshmi Saroja Nalam, Bangalore (IN)

(21) Appl. No.: 18/172,804

(22) Filed: Feb. 22, 2023

(51) Int. Cl. G06F 21/56; G06F 21/55

(52) U.S. Cl. CPC G06F 21/564; G06F 21/552

(57) ABSTRACT

One or more embodiments of the invention relate to methods, systems, and non-transitory computer readable mediums storing instructions for determining how often to create restore points. The embodiments of the invention use machine learning to evaluate the current configuration and status of a computing device to determine an optimal frequency/time for creating restore points. By utilizing machine learning to analyze current system telemetry and other information such as system logs, the one or more embodiments of the invention, are able to efficiently adjust the frequency either more frequent or less frequent given both the potential for system failure and available physical storage space. This and other improvements allow the one or more embodiments of the invention to provide for better data protection with less downtime and greater reliability.

### BACKGROUND

In a computing environment, a system might be running multiple applications that are either working together or dependent on each other. When any changes are made to the system and/or one or more of its applications, whether accidentally, as part of a planned update, or maliciously, the system may become increasingly unstable and/or suffer complete failure. Once this occurs the user is forced to restore the system to the last backed up and/or its initial setting. This may result in significant data loss and down time.

### SUMMARY

In general, embodiments described herein relate to a method for creating restore points. The method initially retrieves device telemetry data and determines using the telemetry a performance rate for the device. Also using the device telemetry, the method determines a criticality of applications associated with the device. Once the performance rate and criticality of the applications associated with the devices are determined, machine learning is applied to the performance rate and criticality to determine a restore point frequency. This restore point frequency and the performance rate are stored in a restore point policy file, wherein after the storing, the restore points are periodically produced at the restore rate frequency.

In general, embodiments described herein relate to a non-transitory computer readable medium comprising computer readable program code. The computer readable code, which when executed by a computer processor, enables the computer processor to perform a method for creating restore points. The method initially retrieves device telemetry data and determines using the telemetry a performance rate for the device. Also using the device telemetry, the method determines a criticality of applications associated with the device. Once the performance rate and criticality of the applications associated with the devices are determined, machine learning is applied to the performance rate and criticality to determine a restore point frequency. This restore point frequency and the performance rate are stored in a restore point policy file, wherein after the storing, the restore points are periodically produced at the restore rate frequency.

In general, embodiments described herein relate to a system comprising a processor and a memory. The memory includes instructions, which when executed by the processor performs a method for creating restore points. The method initially retrieves device telemetry data and determines using the telemetry a performance rate for the device. Also using the device telemetry, the method determines a criticality of applications associated with the device. Once the performance rate and criticality of the applications associated with the devices are determined, machine learning is applied to the performance rate and criticality to determine a restore point frequency. This restore point frequency and the performance rate are stored in a restore point policy file, wherein after the storing, the restore points are periodically produced at the restore rate frequency.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2 shows a flowchart of a method for determining a restore point creation frequency in accordance with one or more embodiments of the invention.

FIG. 3 shows a flowchart of a method for determining a new optimized restore point frequency in accordance with one or more embodiments of the invention.

FIG. 4 shows a computing system in accordance with one or more embodiments of the invention.

### DETAILED DESCRIPTION

In the below description, numerous details are set forth as examples of embodiments described herein. It will be understood by those skilled in the art, and having the benefit of this Detailed Description, that one or more embodiments of the embodiments described herein may be practiced without these specific details and that numerous variations or modifications may be possible without departing from the scope of the embodiments described herein. Certain details known to those of ordinary skill in the art may be omitted to avoid obscuring the description.

In the below description of the figures, any component described with regards to a figure, in various embodiments described herein, may be equivalent to one or more like-named components described with regard to any other figure. For brevity, descriptions of these components will not be repeated with regards to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to methods, systems, and non-transitory computer readable mediums storing instructions for determining how often to create restore points. The embodiments described herein use machine learning to evaluate the current configuration and status of a computing device to determine an optimal frequency/time for creating restore points. The machine learning may consider a plurality of operational statistics such as, but not limited to, CPU utilization, device I/O size (the amount of data the device is communicating with external devices), and device I/O rate (the speed such as bytes per second that the device is communicating with outside devices) and may be adjusted when changes in the system are observed that necessitate a greater frequency, such as potential application failures due to cyber-attacks, upgrades, or other issues.

Previous methods of data protection did not provide a sufficient method or intelligence to efficiently produce restore points. Generally, restore points were produced on a periodic basis such as once a week or more often and/or during or before major updates to an operating system or other critical application or process. This, however, is often not frequent enough, especially with the prevalence and destructiveness of cyber-attacks.

Previously attempts to ensure that restore points were created often enough to minimize damage caused by cyber-attacks and/or other system/device failures, have been to simply increase the frequency of creating restore points. However, restore points typically take up large amounts of storage space and during times when little change is occurring in the system may be unnecessary. While in previous attempts this inefficient use of physical storage space may have been an acceptable trade-off, with increased use of data, both by individual computers and in large datacenters; producing frequent unnecessary restore points is often no longer acceptable or possible. Older restore points must be deleted more often in order to avoid over use of available storage space, however this may result in not having a functioning restore point that dates before a corrupting change in the system occurs. Alternatively, one is forced to decrease the frequency of the restore points as available storage space decreases and data amounts and complexity increase.

One or more embodiments of the invention seeks to overcome these deficiencies of the previous methods by using an intelligence to dynamically determine when to produce restore points and/or how frequently. By utilizing machine learning to analyze current system telemetry and/or other information such as system logs, the one or more embodiments of the invention are able to efficiently adjust the frequency to be either more frequent or less frequent as appropriate to better correspond to both the potential for system failure and available physical storage space. This and other improvements allow the one or more embodiments of the invention to provide for better data protection with less downtime and greater reliability.

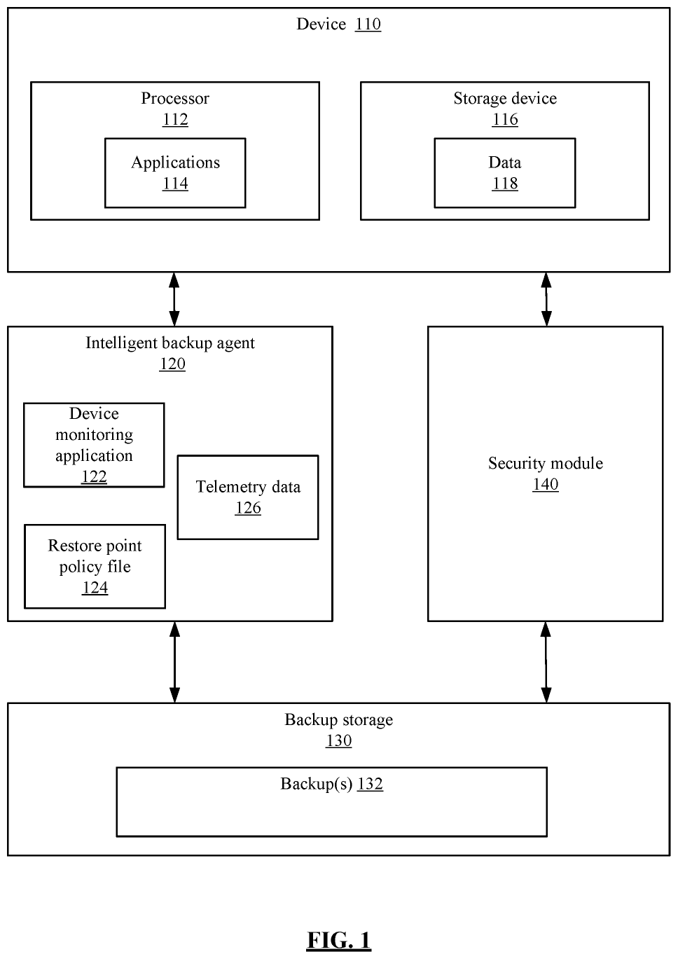

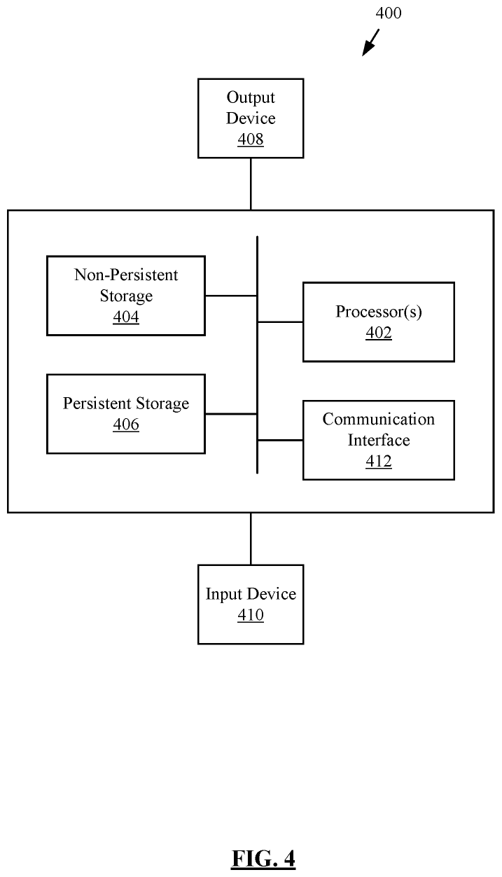

FIG. 1 shows a diagram of a system that performs the claimed methods in one or more embodiments of the invention. The system includes a device (110), an intelligent backup agent (120), a security module (140) and backup storage (130). Each component may be part of a single computational device, such as described in more detail with regards to FIG. 4, or one or more separate computational devices connected to each other through a network such as the Internet or a high seed local network. For simplicity, the system shown in FIG. 1 only shows a single device (110), however, this is only representative, and the system may include any number of devices.

In one or more embodiments of the invention, the device (e.g., 110) may be implemented as a computing device (e.g., 600, FIG. 6). A computing device may be, for example, a mobile phone, a tablet computer, a laptop computer, a desktop computer, a server, a distributed computing system such as a datacenter, edge resource, or a cloud resource. The computing device may include one or more processors, memory (e.g., random access memory), and persistent storage (e.g., disk drives, solid-state drives, etc.). The device (110) may include instructions, stored on the persistent storage, that when executed by the processor(s) of the computing device, cause the device to perform the functionality of the device (e.g., 110) described throughout this application.

The device (110) may include a processor (112) and storage (116). The processor may comprise of one or a plurality of processors or a group of processors such as a central processing unit (CPU) or graphics processing unit (GPU) depending on the type of device. In one or more embodiments, the processor may instead take the form of at least one virtual machine that is hosted by a plurality of processors or information handling machines networked together.

The processor(s) (112) may be a physical device, or it may be implemented as a logical device. The logical device may utilize the computing resources of any number of computing devices and thereby provide the functionality of the processor(s) (112) described throughout this application.

The processor(s) (112) host one or more applications (114) that may comprise of web services, databases, operating systems (OS), games, virtual machines, and/or any other applications that one or more users or processes depend on. The processor(s) (112) may host or be operatively connected to at least one storage device (e.g., 116).

In one or more embodiments the device (110) includes storage (116) that may be physical storage or logical/virtual storage e.g., (not shown) that are connected to the processor (112). The storage device (116) may be one or more physical storage devices such as a hard disk drive, solid disk drive, tape drives, and or other physical storage mediums of any number of computing devices. Additionally, the device (110) may utilize remote storage or resources such as those located externally on a cloud environment, other device (e.g., 110), or other location. The logical storage devices may utilize any quantity of hardware storage resources of any number of computing devices for storing data. For example, the storage may utilize portions of any combination of hard disk drives, solid state disk drives, tape drives, and/or any other physical storage medium of any number of computing devices.

The storage device (116) stores data (e.g., 118) that may be related to the one or more applications (e.g., 114). The data may also be data produced by one or more processes and/or one or more of the other components of the system such as, but not limited to, the intelligent backup agent (120) and backup storage (130). The data may be in the form of a database or in any other form useful to the applications (114) and any other process being hosted or processed by the processor (112).

In one or more embodiments of the invention, the system includes an intelligent backup agent (120). The intelligent backup agent (120) may perform backups and/or restoration of assets located on the device (e.g., 110). The system may also comprise backup storage (130) for storing any number of backups. Both the intelligent backup agent (120) and backup storage (130) may be part of the same device (e.g., 110), or may be separate standalone systems.

The intelligent backup agent (120), backup storage (130), and device (110) may be located in the same facility/datacenter, or they may be geographically dispersed. For example, in a non-limiting example, the device (110) may be a local personal computer (PC) and the intelligent backup agent (120), and backup storage (130) may be located at a manufacture's datacenter or cloud environment. The system may comprise additional, fewer, and/or other components without departing from the invention. Each of these components may be operatively connected via any combination of wireless and/or wired networks.

In one or more embodiments of the invention, the intelligent backup agent (e.g., 120) interacts with the device (e.g., 110) as well as a security module (e.g., 140) via a network (not shown). The intelligent backup agent (120) may be a separate computing system that coordinates backups and restorations and either comprises or communicates with a backup storage (e.g., 130) for storing a completed backup including a backup in the form of a restore point. Alternatively, or in addition to, in one or more embodiments of the invention, the intelligent backup agent may be part of the device (e.g., 110) or other components of the system. Other configurations of the intelligent backup agent (e.g., 120) and the device (e.g., 110) may be utilized without departing from the invention.

In one or more embodiments of the invention, the intelligent backup agent (120) includes a device monitoring application (e.g., 122), restore point policy file (e.g., 124) and telemetry data (e.g., 126). The intelligent backup agent (120) may include more or less components then shown in FIG. 1 without departing from the invention. Each of the components (e.g., 122, 124, and 126) may be part of the intelligent backup agent (120), the device (110), security module (140) and/or the backup storage (130). For example, in a non-limiting example, the restore point policy file (e.g., 124) may be stored in storage associated with the device (e.g., 110) or on the backup storage (e.g., 130). Each of these components (e.g., 122, 124, and 126) will be described in more detail below.

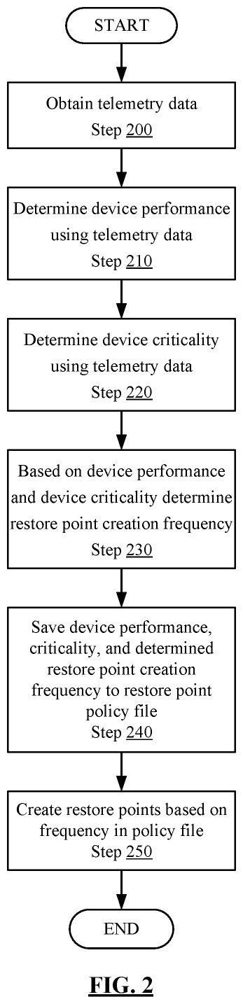

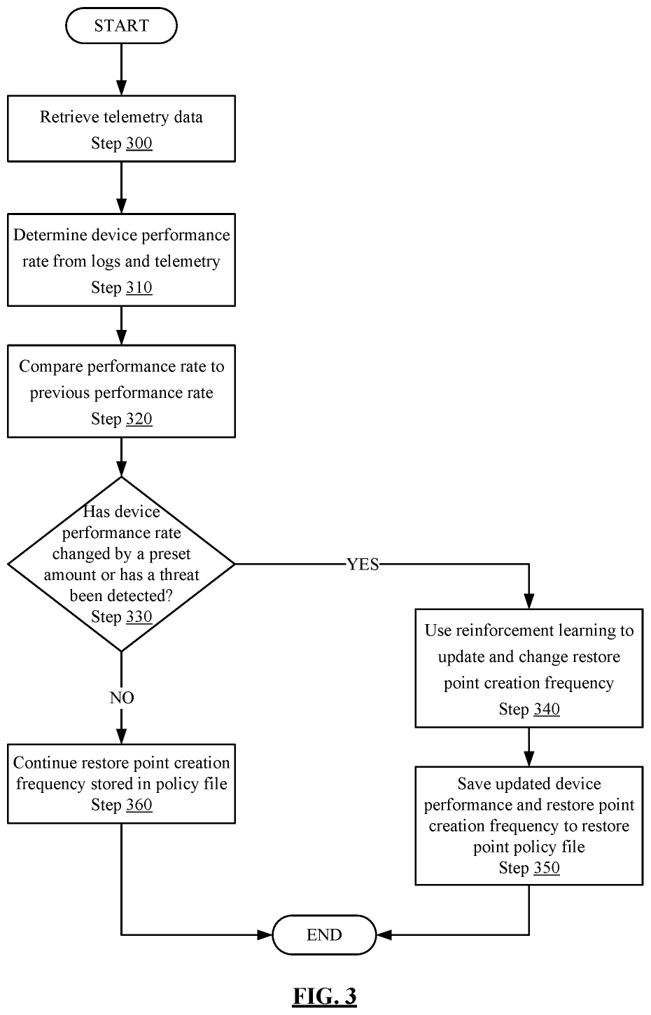

In one or more embodiments of the invention, the intelligent backup agent (120) may generate and provide to the backup storage device (130) backup data in the form of one or more backups (e.g., 132). These one or more backup may be in the form of restore points as well as any other data that is produced by the intelligent backup agent (120) in the process of performing a backup or a restoration based on backup policies implemented by the intelligent backup agent (120). The intelligent backup agent (e.g., 120) may also perform restoration from the backup (e.g., 132) and any other data that is associated with a backup (e.g., 132). The backup policies may specify a schedule for when restore points are to be produced. The method of producing the schedule of producing the restore points is described in more detail below with regards to the methods described in FIGS. 2 and 3.

As discussed above, the intelligent backup agent (120) includes a device monitoring application (122). The device monitoring application retrieves telemetry as well as logs and other information from the device (110). This telemetry data (e.g., 126) is stored in the intelligent backup agent (e.g., 120) or alternatively in either the device's storage (e.g., 116) or backup storage (e.g., 130). The telemetry data (126) includes such data as CPU utilization, device I/O size, device I/O per second, active applications, application dependencies and other useful information with regards to the functioning of the device (110) and applications hosted by it. The device monitoring application (122) uses this telemetry data (e.g., 126) to determine a restore point frequency which is then saved in the restore point policy file (124).

The device monitoring application (122) leverages machine learning to analyze the telemetry data (e.g., 126) and produce the restore point policy. The machine learning in one or more embodiments of the invention, uses reinforcement learning, however, other forms of machine learning may be used without departing form the invention. Reinforcement learning is a type of machine learning, which does not need labelled input/output pairs to be present and may use a Markov decision process (MDP) in order to determine an optimized solution.

As described in more detail with regards to FIGS. 2 and 3 the device monitoring application (122) analyzes the telemetry data (e.g., 126) for such things as CPU utilization, device I/O size and device I/O per second to determine a performance rate for the device. Based on this and the device criticality, the device monitoring application (122) determines an initial restore point frequency and saves this along with the performance rate to the restore point policy file (124). Periodically, for example, once every day, week or other user configured time frame, the device monitoring application (122) retrieves more telemetry data from a device (e.g., 110) and determines if the performance rate for the device (e.g., 110) has change. If it has changed, using the machine learning, the device monitoring application (122) produces a revised restore point frequency and saves it to the restore point policy file (124). This revised restore point frequency may be more or less that which was initially determined depending on changes that have occurred in the device (e.g., 110).

Once this restore point policy file (e.g., 124) is initially or subsequently produced, the intelligent backup agent (120) periodically produces restore points. In one or more embodiments of the invention, the restore points may take the form of a full backup, snapshot, or other common form of backup that would allow for a successful system restoration. The restore points along with any other type of backups are stored in backup storage (130) as one or more backups (e.g., 132).

In one or more embodiments of the invention, the intelligent backup agent (120) stores backup data or backups (132) on backup storage (e.g., 130). The backup storage (e.g., 130) may store data and/or files such as backup data, metadata, as well as definitions rules, procedures, and other pertinent information for performing backups and/or restoration of device (110). The backup storage (130) may comprise one or more processors, memory (e.g., random access memory), and persistent storage (e.g., disk drives, solid state drives, etc.). In one or more embodiments of the invention, the backup storage (130), as well as the intelligent backup agent (120) itself, may also, or alternatively, comprise of off-site storage including but not limited to, cloud base storage, and long-term storage such as tape drives, depending on the particular needs of the user and/or the system.

In one or more embodiments of the invention, the intelligent backup agent (120) stores assets that have been selected for backing up. The assets may take the form of one or more files and/or folders that are stored in the storage (116) of the device (110). The assets may be stored as backup data in a hierarchical organization similar to that of the file-system from which the backup data is backed up. In the case of a restore point, the assets may also include state information and operating system information that may not be ordinarily stored in the backup data.

In one or more embodiments of the invention, the intelligent backup agent (120) is a physical device. The physical device may comprise circuitry. The physical device may be, for example, a field-programmable gate array, application specific integrated circuit, programmable processor, microcontroller, digital signal processor, or other hardware processor. The physical device may be adapted to provide the functionality of the intelligent backup agent (120) described throughout this application.

In one or more embodiments of the invention, the backup agent (120) may restore a backup (e.g., 132) and/or restoration point stored in the backup storage (130). While described as being performed by a backup agent (e.g., 120), restorations may be performed by a separate restoration agent (not shown) or any other component or agent that has access to both backup storage (e.g., 130) and the device (e.g., 110). When the intelligent backup agent (e.g., 120) or other equivalent component of the system, receives a request for a restoration of a restore point, the backup agent (e.g., 120) or equivalent component, retrieves the backup/restoration point stored in the backup storage (e.g., 130) and restores the data to its original location in the device (110). In the case of a restoration point, the intelligent backup agent (120) may also perform a system restoration on the device (e.g., 110). Alternatively, in one or more embodiments of the invention, the data in the backup(s) (e.g., 132) may be restored to a file-system or device different from the original device (e.g., 110) where it was originally backed up from as directed by a user, administrator, or other party that requested the restoration.

In one or more embodiments of the invention, the intelligent backup agent (120) is implemented as a computing device (see e.g., FIG. 4). A computing device may be, for example, a mobile phone, tablet computer, laptop computer, desktop computer, server, distributed computing system, or cloud resource. The computing device may comprise one or more processors, memory (e.g., random access memory), and persistent storage (e.g., disk drives, solid state drives, etc.). The computing device may comprise instructions stored on the persistent storage that when executed by the processor(s) of the computing device cause the computing device to perform the functionality of an intelligent backup agent (e.g., 120) described throughout this application.

In one or more embodiments of the invention, the intelligent backup agent (120) is implemented as computer instructions, e.g., computer code, stored in a persistent storage that when executed by a processor (e.g., 112) of the device (e.g., 110) provide the functionality of the intelligent backup agent (e.g., 120) described throughout this application. Alternatively, in one or more embodiments of the invention, the intelligent backup agent (e.g., 120) may be implemented on the production host, a client (not shown), or other component of the system, which may provide the functionality of the intelligent backup agent (e.g., 120) described throughout this application.

In one or more embodiments of the invention, a security module (140) is provided. The security module (140) may interact with the device (e.g., 110) and the intelligent backup agent (e.g., 120) to provide cyber-security services to the device (e.g., 110) and/or the intelligent backup agent (e.g., 120). In one or more embodiments of the invention, the security module (140) may monitor backup data sets (e.g., 132) and/or the device (e.g., 110) for changes that may indicate corruption, such as corruption that occurs as a result of a cyber-attack.

The security module (140) includes hardware and/or applications that perform cyber-security functions. These functions include but are not limited to detecting ransomware, trojans, viruses, worms, botnets, and/or other types of malware. The security module (140) may include advance analytics and other applications for detecting malware. The security module may be maintained by an administrator, manufacture, third-party, or other user of the system.

In one or more embodiments of the invention, the security module (e.g., 140) may include machine learning or AI for detecting changes in data that are indicative of a cyber-attack. By monitoring the data (e.g., 118) as well as the backups (e.g., 132) stored on backup storage (e.g., 130), for changes in the data, the security module (e.g., 140) may detect when changes occur in the data that may be indicative of a cyber-attack such as a ransomware attack. Such indications may be, but not limited to, a detection that a hash value of the data unexpectedly changes or changes more than a preset threshold. Other unexpected changes that may be indicative of a cyber-attack are changes in file type, encryption, and file size. The security module (e.g., 140) also includes the ability to be updated. This allows the security module (e.g., 140) to be able to detect future threats that are not currently anticipated.

In one or more embodiments of the invention, when the security module (e.g., 140) determines that a cyber-attack is occurring or has occurred, the security module may cause the intelligent backup agent (e.g., 120) to update the restore point policy file (e.g., 124). In one or more embodiments of the invention, this may cause more frequent restore points to be made, and/or the identification of a previous restore points stored in the backups (e.g., 132) that is free from the corruption caused by a successful cyber-attack.

In one or more embodiments of the invention, the security module (e.g., 140) may be implemented as computing devices (e.g., 400, FIG. 4). A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid-state drives, etc.). The computing device may include instructions, stored on the persistent storage, that when executed by the processor(s) of the computing device, cause the computing device to perform the functionality of the security module (e.g., 140) described throughout this application. Alternatively, in one or more embodiments of the invention, the security module (e.g., 140) may also be implemented as logical devices, as discussed above.

In one or more embodiments of the invention, the device (110), the intelligent backup agent (e.g., 120), the security module (e.g., 140) as well as other components of the system, such as clients (not shown), communicate through a network (not shown). The network may take any form, including any combination of wireless and/or wired networks. The network may be a local network (LAN) or a wide area network (WLAN) including the Internet, or a private enterprise network that connects more than one location. The network may be any combination of the above networks, other known network, or any combination of network types. Alternatively, in one or more embodiments of the invention, all of the components of FIG. 1 may be part of the same device.

While FIG. 1 shows a configuration of components, other configurations may be used without departing from the scope of embodiments described herein. For example, although FIG. 1 shows all components as part of two devices, any of the components may be grouped in sets of one or more components which may exist and execute as part of any number of separate and operatively connected devices. Accordingly, embodiments disclosed herein should not be limited to the configuration of components shown in FIG. 1.

FIG. 2 shows a flowchart describing a method for initially determining a restore point creation frequency and saving it to a restore point policy file. The method may be performed, for example, by the intelligent backup agent (e.g., 120, FIG. 1), security module (e.g., 140, FIG. 1) and/or any other part of the system shown in FIG. 1 including the device (e.g., 110, FIG. 1).

Other components of the system, including those illustrated in FIG. 1 may perform all, or a portion of the method of FIG. 2 without departing from the invention. While FIG. 2 is illustrated as a series of steps, any of the steps may be omitted, performed in a different order, additional steps may be included, and/or any or all the steps may be performed in a parallel and/or partially overlapping manner without departing from the invention.

In step 200, the method begins by obtaining telemetry data. The telemetry data may be retrieved from a device that is a standalone device such as, but not limited to, a PC; or it may be part of a datacenter or other large combination of computing devices that is performing the claimed method. In one or more embodiments of the invention, the telemetry may include data about the processor(s) functioning and utilization, device load, device I/O size, and the number of device I/O per second. Other data may also be retrieved in step 200 such as the identity and number of applications the device is hosting, the interactions between the individual applications, and/or the criticality of the applications. Other information may be retrieved in step 200 and the data may or may not take the form of telemetry data and may be retrieved by other means such as accessing system logs without departing from the invention.

Once the telemetry and/or other information is retrieved in step 200, device performance is determined using the telemetry and/or other information in step 210. In one or more embodiments the performance rate is determined by analyzing a combination of CPU or processor utilization with device I/O size and rate. By analyzing these and any other factors that user, administrator, manufacture, or other concerned party determines should be used to determine a performance rate, the method may determine when system usage has increased compared to previous measurements. This may occur as a result of malware or of system failure. For example, if a storage device begins to fail, this may be indicated by a change in I/O rate. In another non-limiting example malware might cause the CPU or processor to be utilized at a much higher level them during normal operation.

After determining the device performance or simultaneously with determining the device performance, the device criticality may also be determined in step 220. The device criticality is determined from the telemetry data or may be determine by log data that is retrieved form the device. In one or more embodiments of the invention, the device criticality may be determined by looking at the specific applications being hosted by the device. If there are a plurality of applications that are frequently accessed or database applications that is frequently accessed by other devices, the device criticality may be determined to be high. Alternatively, or in addition, the applications may include flags that indicate the criticality of the applications. These flags may be automatically determined based on network and processor criteria or may be set by users, administrators, programmers, and/or manufacturers.

Once the device performance is determined in step 210 and the device criticality is determined in step 220, the method proceeds to step 230. In step 230, a restore point creation frequency is determined based on the device criticality and device performance rates calculated in steps 210 and 220. In one or more embodiments of the invention, the device criticality and device performance rates are analyzed by machine learning to determine a restore point creation frequency. The machine learning initially may consider the device criticality, current performance rate, as well as information such as available backup storage space to determine an optimal frequency for producing restoration points.

In one or more embodiments of the invention, the method utilizes machine learning in the form of reinforcement learning to determine an ideal restoration point creation frequency. The reinforcement learning analyzes the performance rate of the device and device criticality to determine a statistically ideal restoration point creation frequency. This ideal frequency is then modified over time as the performance rate and criticality change, as will be discussed in more detail with regards to the method shown in FIG. 3.

In one or more other embodiments of the invention, the initial restore point creation frequency does not use machine learning, and instead is set by a user, administrator, and/or manufacture. This initial restore point creation frequency may be a preset frequency as determined by the operating system (OS). For example, the OS may specify that a restore point is created every seven days, may specify once a day, or any other frequency. Alternatively, the restore point creation frequency may be set as part of a backup policy that is determined based on the system utilization, criticality, and/or a user/company policy.

In one or more embodiments of the invention, the initial restore point creation frequency is a constant frequency such as, but not limited to, every five days, every two weeks, every month, etc. In one or more other embodiments of the invention, the frequency of performing the restore points may be based in part on real-time telemetry; the restore points are done at the constant frequency as well as when certain actions are performed by the device such as application updates or hardware changes. Other methods of determining the initial restore point creation frequency may be used without departing from the invention.

Once the restore point creation frequency is determined in step 230, the method proceeds to step 240. In step 240, both the initial restore point creation frequency as well as other data obtained from the telemetry including device performance and criticality is saved to the restore point policy file. This policy file may be stored on the device's storage device (e.g., 110) or in a storage device associated with a backup agent and/or separate backup storage. This policy file allows for determining changes in the device performance/criticality that necessitate changing the restore point frequency.

The frequency that is determined in step 230 and saved to the restore point policy file in step 240, is then used to create restore points in step 250 on the device on which the response point policy file is stored. The restore points may take the form of snapshots of the system and its data or may take any other form that allows for efficient and complete restoration of the system after a system failure. In one or more embodiments of the invention, the restore point may be a pointer to one or more full backups and incremental backups. The restore point may take any form that a backup policy specifies and that has been determined to be able to restore a system to a previous state.

Once step 250 is completed, the method of FIG. 2 may end.

FIG. 3 shows a flowchart describing a method for revising the restore point creation frequency. The method may revise the restore point creation frequency as initially determined in the method shown in FIG. 2 or may revise it as determined in any other way including being manually included in a policy file by a user or manufacture. The method of FIG. 3 may be performed, for example, by the intelligent backup agent (e.g., 120, FIG. 1), security module (e.g., 140, FIG. 1) and/or any other part of the system shown in FIG. 1 including the device (e.g., 110, FIG. 1).

Other components of the system, including those illustrated in FIG. 1 may perform all, or a portion of the method of FIG. 3 without departing from the invention. While FIG. 3 is illustrated as a series of steps, any of the steps may be omitted, performed in a different order, additional steps may be included, and/or any or all the steps may be performed in a parallel and/or partially overlapping manner without departing from the invention.

In step 300, the method begins by obtaining telemetry data. The telemetry data may be retrieved from a device that is a standalone device such as, but not limited to a PC, or it may be part of a datacenter or other large combination of computing devices that is performing the claimed method. In one or more embodiments of the invention, the telemetry may include data about the processor(s) functioning and utilization, device load, device I/O size, and the number of device I/O per second. Other data may also be retrieved in step 300 such as the identity and number of applications the device is hosting, the interactions between the individual applications, and the criticality of the applications. Other information may be retrieved in step 300 and the data may or may not take the form of telemetry data and may be retrieved by other means without departing from the invention.

Once the telemetry and/or other information is retrieved in step 300, device performance is determined using the telemetry and/or other information in step 310. In one or more embodiments the performance rate is determined by analyzing a combination of CPU or processor utilization with device I/O size and rate. By analyzing these and any other factors that a user, administrator, manufacture, or other concerned party determines should be used to determine a performance rate, the method may determine when system usage has increased compared to previous measurements. This may occur as a result of malware or of system failure.

In one or more embodiments of the invention, a change in the performance rate may be triggered by a change in one or more hardware devices associated with the device. For example, in a non-limiting example, this may be because a new hardware device such as a new hard-drive has been installed. Another, non-limiting example is, if a storage device begins to fail, this may be indicated by a change in I/O rate.

In one or more embodiments of the invention, a change in the performance rate may be triggered by a change in one or more of the applications hosted by the device. This may be as a result of performing an update, accidental or malicious installation of malware, or the addition of a new application hosted by the device. In a non-limiting example malware might cause the CPU or processor to be utilized at a much higher level them during normal operation. In a second non-limiting example a new database may be installed which is hosted by the device, this may result in greatly increase processor use as well as I/O operations as the database is frequently accessed, which may put more strain on the underlying hardware, causing more frequent system failures and/or conflicts between applications.

After determining the device performance in step 310, the previous performance rate is retrieved from the policy file and compared with the new performance rate in step 320. The difference between the two performance rates is calculated and compared in step 330. If the performance rate has changed by a preset amount the method proceeds to step 340, otherwise the method proceeds to step 360. The preset amount may be a percentage or other number determined by a user and/or administrator to be sufficient to indicate a change has occurred in the system that would necessitate increasing or decreasing the restore point creation frequency. Alternatively, this amount may be determined by a security module as a result of detected or suspected cyber-security threats to the system.

In one or more embodiments of the invention, in step 330, a second determination may be made that a security threat has been detected. This detection might be by a separate security module and/or anti-viral protection applications operating on the device. When a potential security threat is detected, the method may proceed to step 340. Otherwise, if no security threat has been detected and the performance rate is within a preset amount the method proceeds to step 360.

In step 340, the restore point creation frequency is updated based on the device performance rates calculated in steps 310. In one or more embodiments of the invention, the device performance rates are analyzed by machine learning to determine a new restore point creation frequency. The machine learning may take into account the device criticality, current performance rate, as well as information such as available backup storage space to determine a new optimal frequency for producing restoration points.

In one or more embodiments of the invention, the method utilizes machine learning in the form of reinforcement learning to determine a new/updated ideal restoration point creation frequency. The reinforcement learning analyzes the performance rate of the device and device criticality to determine a statistically ideal restoration point creation frequency. This ideal frequency is then modified over time as the performance rate and criticality change. This change may also be determined based on comparisons with other devices that have a similar performance rate or security issue. The reinforcement learning attempts to find the best rate that does not overly use the available storage space but is frequent enough to ensure that an updated restore point is available if the system fails.

Once the updated restore point creation frequency is determined in step 340, the method proceeds to step 350 where the new restore point creation frequency is saved to the policy file on the device (similar to the process in step 240) and the method ends.

Returning to step 330, if the performance rate has not changed by the preset amount and no security threat has been detected, the method proceeds to step 360, where the restore point creation frequency is maintained at the last restore point frequency.

The method of FIG. 3 may end after either step 360 or step 350.

### Example

The following is a non-limiting example of a system that uses the methods described above in FIGS. 2 and 3. In the following example a user has a PC, based on the configuration of the OS manufacture a snapshot or backup that may be used to restore the system (a restore point) is performed every three weeks or when a major system change occurs such as an OS update.

If the user of this PC installs malware that results in the system failing, the user may restore the PC with the restore point (snapshot) that was last taken. Using only the OS recommended frequency, however, the user potentially could lose up to three weeks of data.

If the user instead uses the method of FIGS. 2 and 3 less loss of data may occur. When the malware is first installed, the method increases the frequency that the restore points are made, due to detecting that a significant change in processor use and/or I/O rate has occurred. In one or more embodiments, this may be as frequent as once a day or some other optimal rate. This allows the user to restore the system back to a more recent restore point after having a security application or module remove the malware. This potentially saves the user time and effort restoring lost data.

A second example is a datacenter where a critical database is installed and hosted. In accordance with the method of FIGS. 2 and 3, since the database is indicated as being critical the backup/restore points are produced more often. If a cyber-attack occurs, targeting the database, the performance rate of the datacenter may change reflecting increased I/O or processing as the malware attempts to access, encrypt, and/or copy the data from the database. Based on detecting that a cyber-attack is occurring, more restoration points may be created, so that if and when the cyber-attack becomes successful, less or no data loss will occur.

Other examples of using the methods outlined above with regards to the method of FIGS. 2 and 3 may be used. The specific types of devices and/or system as well as the reasons for changing the restoration point creating frequency may be used, the above examples are non-limiting and intended as an example only.

### End Example

As discussed above, embodiments of the invention may be implemented using computing devices. FIG. 4 shows a diagram of a computing device in accordance with one or more embodiments of the invention. The computing device (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions. For example, the computer processor(s) may be one or more cores or micro-cores of a processor. The computing device (400) may also include one or more input devices (410), such as a touchscreen, keyboard, mouse, microphone, touchpad, electronic pen, or any other type of input device. Further, the communication interface (412) may include an integrated circuit for connecting the computing device (400) to a network (not shown) (e.g., a local area network (LAN), a wide area network (WAN) such as the Internet, mobile network, or any other type of network) and/or to another device, such as another computing device.

In one embodiment of the invention, the computing device (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many diverse types of computing devices exist, and the aforementioned input and output device(s) may take other forms.

In general, embodiments described herein relate to methods, systems, and non-transitory computer readable mediums storing instructions for determining how often to create restore points. The embodiments described herein use machine learning to evaluate the current configuration and status of a computing device to determine an optimal frequency/time for creating restore points. By utilizing machine learning to analyze current system telemetry and other information such as system logs, the one or more embodiments of the invention, are able to efficiently adjust the frequency either more frequently or less frequently given both the potential for system failure and available physical storage space. This and other improvements allow the one or more embodiments of the invention to provide for better data protection with less downtime and greater reliability.

The problems discussed above should be understood as being examples of problems solved by embodiments of the invention, and the invention should not be limited to solving the same/similar problems. The disclosed invention is broadly applicable to address a range of problems beyond those discussed herein.

While embodiments described herein have been described with respect to a limited number of embodiments, those skilled in the art, having the benefit of this Detailed Description, will appreciate that other embodiments may be devised which do not depart from the scope of embodiments as disclosed herein. Accordingly, the scope of embodiments described herein should be limited only by the attached claims.

What is claimed is:

1. A method for creating restore points, the method comprising:
retrieving device telemetry data;
determining, using the device telemetry, a performance rate for the device;
determining, using the device telemetry, a criticality of applications associated with the device;
applying machine learning to the performance rate and criticality to determine a restore point frequency;
storing the restore point frequency and performance rate to a restore point policy file, wherein, after the storing, the restore points are periodically produced at the restore point frequency.

2. The method of claim 1, the method further comprising:
determining a recalculated performance rate for the device;
comparing the recalculated performance rate with the performance rate stored in the policy file;
determining, based on the comparing, that the recalculated performance rate differs from the performance rate by a predetermined amount;
applying, when the difference is determined to be different than the predetermined amount, machine learning to the recalculated performance rate to determine a new optimized restore point frequency;
storing the new optimized restore point frequency and recalculated performance rate to the policy file, wherein, after the storing, the restore points are periodically produced at the new optimized restore point frequency.

3. The method of claim 2, wherein determining the recalculated performance rate is performed periodically.

4. The method of claim 2, wherein determining the recalculated performance rate is triggered by a change in the device.

5. The method of claim 4, wherein the change in the device is an update to one or more applications hosted by the device.

6. The method of claim 4, wherein the change in the device is a change in one or more hardware devices associated with the device.

7. The method of claim 2, wherein the new optimize restore point frequency is a higher frequency then the optimized restore point frequency.

8. The method of claim 2, wherein the new optimized restore point frequency is increased when a security module determines that malware is present.

9. The method of claim 1, wherein the machine learning uses reinforcement learning.

10. The method of claim 1, wherein the performance rate is calculated using the telemetry data comprising at least CPU utilization of the device and device I/O size.

11. A non-transitory computer readable medium comprising computer readable program code, which when executed by a computer processor enables the computer processor to perform a method for creating restore points, the method comprising:
retrieving device telemetry data;
determining, using the device telemetry, a performance rate for the device;
determining, using the device telemetry, a criticality of applications associated with the device;
applying machine learning to the performance rate and criticality to determine a restore point frequency;
storing the restore point frequency and performance rate to a restore point policy file, wherein, after the storing, the restore points are periodically produced at the restore point frequency.

12. The non-transitory computer readable medium of claim 11, the method further comprising:
determining a recalculated performance rate for the device;
comparing the recalculated performance rate with the performance rate stored in the policy file;
determining, based on the comparing, that the recalculated performance rate differs from the performance rate by a predetermined amount;
applying, when the difference is determined to be different than the predetermined amount, machine learning to the recalculated performance rate to determine a new optimized restore point frequency;
storing the new optimized restore point frequency and recalculated performance rate to the policy file, wherein, after the storing, the restore points are periodically produced at the new optimized restore point frequency.

13. The non-transitory computer readable medium of claim 12, wherein determining the recalculated performance rate is triggered by a change in the device.

14. The non-transitory computer readable medium of claim 12, wherein the new optimized restore point frequency is increased when a security module determines that malware is present.

15. The non-transitory computer readable medium of claim 11, wherein the machine learning uses reinforcement learning.

16. A system comprising:
a processor; and
a memory that includes instructions, which when executed by the processor, performs a method for creating restore points, the method comprising:
retrieving device telemetry data;
determining, using the device telemetry, a performance rate for the device;
determining, using the device telemetry, a criticality of applications associated with the device;
applying machine learning to the performance rate and criticality to determine a restore point frequency;
storing the restore point frequency and performance rate to a restore point policy file, wherein, after the storing, the restore points are periodically produced at the restore point frequency.

17. The system of claim 16, wherein the method further comprises:
determining a recalculated performance rate for the device;
comparing the recalculated performance rate with the performance rate stored in the policy file;
determining, based on the comparing, that the recalculated performance rate differs from the performance rate by a predetermined amount;
applying, when the difference is determined to be different than the predetermined amount, machine learning to the recalculated performance rate to determine a new optimized restore point frequency;
storing the new optimized restore point frequency and recalculated performance rate to the policy file, wherein, after the storing, the restore points are periodically produced at the new optimized restore point frequency.

18. The system of claim 17, wherein determining the recalculated performance rate is triggered by a change in the device.

19. The system of claim 18, wherein the change in the device is a change in one or more hardware devices associated with the device.

20. The system of claim 16, wherein the performance rate is calculated using at least CPU utilization of the device and device I/O size.
